(19) United States
(12) Patent Application Publication
(10) Pub. No.: US 2017/0057074 A1
(43) Pub. Date: Mar. 2, 2017

(54) Working Toolkit

(71) Applicants: Gina Marina D'Avignon, Centurion (ZA); Cedric John Ford, Centurion (ZA)

(72) Inventors: Gina Marina D'Avignon, Centurion (ZA); Cedric John Ford, Centurion (ZA)

(21) Appl. No.: 15/242,743

(22) Filed: Aug. 22, 2016

(30) Foreign Application Priority Data
Sep. 1, 2015 (ZA) 2015/06431

(51) Int. Cl. B25F 1/02; B26B 23/00; B25D 1/00; A01D 7/00; B25G 1/10; B25G 3/02; A01B 1/02; A01B 1/22; B23D 49/10; B25G 1/04

(52) U.S. Cl. CPC B25F 1/02; B23D 49/10; B26B 23/00; B25D 1/00; B25G 1/04; B25G 1/102; B25G 3/02; A01B 1/02; A01B 1/22; A01D 7/00

(57) ABSTRACT

A working toolkit includes an extendible shaft, a tool handle and a tool head, each having connection formations so that the tool handle may be releasably attached to one end of the shaft, and the tool head may be releasably attached to an opposite end of the shaft to form a working tool, and thereafter disassembled for storage and transportation in a compact form. The tool handle may be directly releasably attached directly to the tool head. A variety of connection formations are provided, particularly adapted for a tubular shaft. The working toolkit may include several different tool handles and tool heads for selectively forming a variety of working tools.

### PRIORITY STATEMENT & CROSS-REFERENCE TO RELATED APPLICATIONS

This application claims priority from South Africa Patent Application No. 2015/06431 filed on Sep. 1, 2015, in the names of Gina Marina D'Avignon and Cedric John Ford and entitled “Working Toolkit;” which is incorporated by reference for all purposes.

### TECHNICAL FIELD OF THE INVENTION

This invention relates to hand tools. Specifically the invention relates to a working toolkit.

### BACKGROUND TO THE INVENTION

Working tools such as hammers, saws, axes, brooms, rakes, shovels, spades and the like are often used in an around the home. A number of these tools are considered essential for general garden and household maintenance. Generally people will store these tools in a garage or shed. Purchasing each of these individual tools can however become rather expensive and the number of tools required takes up a lot of storage space. This is particularly a problem when for example going camping, hiking or the like, when it is not possible to transport each individual tool to a remote location.

### SUMMARY OF THE INVENTION

The current invention aims to provide multiple tools that can be readily assembled and disassembled for storage and transport in a compact manner.

According to one aspect of the invention there is provided a working toolkit, which includes:

an extendible shaft having a handle connection formation on one end of the shaft and a tool head connection formation on an opposed end of the shaft;

at least one tool handle having a handle-shaft connection formation for releasably attaching the tool handle to the handle connection formation; and

at least one tool head having a tool head-shaft connection formation for releasably attaching the tool head to the tool head connection formation, thereby to provide an assembled tool.

The at least one tool head may be in the form of any one or more of a round shovel head, a straight spade head, a machete head, a saw head, an axe head, a rake head, a broom head, a hammer head and the like.

The at least one tool handle may be in the form of any of a vertical grip handle and a transverse grip handle. The vertical grip handle when connected to a shaft extends straight from the shaft, substantially parallel to an elongate direction of the shaft, such that in use the palm of a user's hand is coplanar with the shaft. The vertical grip handle is particularly for use with a hammer, saw, axe or the like, tool head. The transverse grip handle when connected to a shaft extends transversely (i.e., substantially non-parallel to an elongate direction of the shaft) (e.g., at 90 degrees to an elongate direction of the shaft), such that in use the palm of a user's hand is perpendicular to the shaft. The transverse grip handle is particularly for use with a spade, shovel, broom, rake or the like, tool head. The transverse grip handle may be in the form of a D-handle (i.e., a handle forming a closed loop).

In one embodiment the extendible shaft may be in the form of a telescopically extendible shaft. In another embodiment the extendible shaft may include a plurality of shaft sections releasably inter-connectable with each other to assemble a suitable shaft length for a particular tool assembly. The shaft sections may include inter-shaft connection formations for releasably connecting one shaft to another. The inter-shaft connection formations, the handle-shaft connection formation on the tool handles, and tool head-shaft connection formation on the tool heads may be in the form of threaded connection formations. In another embodiment the inter-shaft connection formations, the handle-shaft connection formation on the tool handles, and tool head-shaft connection formation on the tool heads may be in the form of complementary outwardly biased push pins and one or more apertures for receiving the push pins.

In one embodiment the extendible shaft may be in the form of elongate tubular members. The tubular members may be in the form of hollow metal tubing. The hollow tubing may have outer diameters between 20 mm and 40 mm, in particular the outer diameters may be about 25 mm, 32 mm or the like. The wall thickness of the hollow tubing may range between 1 mm to 5 mm. In particular the wall thickness may be about, 1.6 mm, 2 mm, 2.5 mm, 3 mm and the like.

The threaded connection formations may comprise a spigot and a complementary socket formation. The spigot formation may have a male thread, and the socket formation may have a complementary female thread.

In one embodiment the threaded connection formations may comprise threaded inserts, inserted into one end of the extendible shaft. In such embodiment the socket formation may be constructed by inserting a female threaded insert into the end of the tubular shaft. The female threaded insert may be cylindrical and having a smooth round outer wall and a threaded inner wall. The smooth round outer wall may be dimensioned to fit tightly into the tubular shaft.

The spigot formation may be constructed by inserting a male threaded insert into the end of the tubular shaft, such that a male thread portion of the insert extends beyond the end of the shaft. In one embodiment the male threaded insert may include a smooth cylindrical portion on one end and a threaded stud on an opposed end. The smooth cylindrical end may be dimensioned to fit tightly into the tubular shaft.

In another embodiment the male threaded insert may include two male threaded studs on each end, and a smooth shoulder portion in between the studs. One male threaded stud may be screwed into a female threaded formation on a shaft. The insert may then either be crimped or welded onto the shaft, to produce a spigot formation.

The male threaded stud may be machined from a solid steel rod. The solid steel rod may be in the form of a steel rod with a length of between 20 mm and 50 mm, in particular the steel rod may be 32 mm, 40 mm or the like in length. The size of the male threaded stud may be between an M12 (approximately 14 mm in diameter) to M30 (approximately 30 mm in diameter).

The threaded inserts may include fastening means, for fastening the inserts in the end of the tubular shaft. The fastening means may be in the form of the insert being friction fitted into the shaft, the shaft including grub screws for fastening the insert to the shaft, constriction means, or the like.

In one embodiment the constriction means may be in the form of a clamp, constrictable around the shaft into which the insert is received. In another embodiment the constriction means may include a slit cut into a wall of an end of the shaft, which is welded closed when the insert is received into that end of the shaft, such that the wall of the shaft is constricted around the insert.

In another embodiment the threaded socket connection formation may be machined into an inner wall of the tubular shaft.

In particular, each shaft section may include a spigot formation on one end and a socket formation on an opposed end. The tool heads and tool handles may include either of a spigot or socket formation. In a particular embodiment the tool heads may have socket formations and the tool handles may have spigot formations complementary to the socket formations of the tool heads, or the tool heads may have spigot formations and the tool handles may have socket formations complementary to the spigot formations of the tool heads, thereby allowing for attachment of the tool handle directly to the tool head (i.e., without attachment of the shaft).

In one embodiment the working toolkit may include a plurality of selectable tool handles and a plurality of selectable tool heads, such that different tools may be assembled from the different tool handles, shaft and tool heads. The tools that may be assembled include any one or more of, a round head shovel, a straight head spade, a machete, a saw, an axe, a rake, a broom, a hammer, a mallet and the like.

The working toolkit may include a carry bag having separate pockets shaped and dimensioned to receive the tool handles, extendible shaft and tool heads.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 shows a working toolkit in accordance with one embodiment of the invention;

FIG. 2 shows a shovel assembled from the working toolkit;

FIG. 3 shows a mallet assembled from the working toolkit;

FIG. 4A shows an exploded view of one embodiment of a spigot formation;

FIG. 4B shows the spigot formation of FIG. 4A and the corresponding socket formation;

FIG. 5 shows another embodiment of a spigot and corresponding socket formation;

FIG. 6 shows yet a further embodiment of a spigot formation.

In the drawings, like reference numerals denote like parts of the invention unless otherwise indicated.

### DETAILED DESCRIPTION OF THE INVENTION

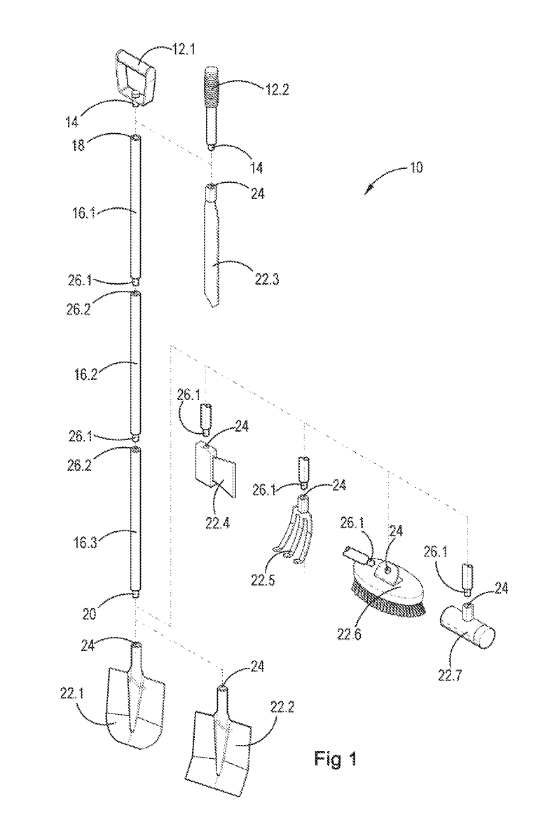

In FIG. 1 reference numeral 10 refers to a working toolkit, which includes a plurality of tool handles 12, an extendible shaft 16, and a plurality of tool heads 22. The extendible shaft 16 has a handle connection formation 18 on one end and a tool head connection formation 20 on an opposed end. The tool handles 12 have handle-shaft connection formations 14 for releasably attaching the tool handle 12 to handle connection formation 18. The tool heads have tool head-shaft connection formations 24 for releasably attaching the tool head 22 to the tool head connection formation 20. By selectively attaching different tool handles 12 and tool heads 22 to the opposite ends of the shaft 12, or by attaching the tool handles 12 directly to the tool heads 22, a selection of assembled tools may be provided.

In this example the working toolkit 10 includes seven selectable tool heads 22, which includes a round shovelhead 22.1, a straight spade head 22.2, a machete and saw head 22.3, an axe head 22.4, a rake head 22.5, a broom head 22.6 and a mallet head 22.7.

In this example the working toolkit 10 includes two selectable tool handles 12, which include transverse grip handle 12.1 and a vertical grip handle 12.2.

The transverse grip handle 12.1 when connected to the shaft 16 extends transversely relative to the shaft 16 substantially at 90 degrees to the elongate direction of the shaft 16, such that in use the palm of a user's hand is perpendicular to the shaft 16. The transverse grip handle 12.1 is particularly for use with a shovel 22.1, spade 22.2, rake 22.5 and broom 22.6 tool head. The transverse grip handle 12.1 is in the form of a so-called D-handle (i.e., a handle forming a closed loop). It is to be appreciated that the use of the transverse grip handle 12.1 is not limited to use with the mentioned tool heads.

The vertical grip handle 12.2 when connected to the shaft 16 extends straight from the shaft 16 substantially parallel to the shaft 16, such that in use the palm of a user's hand is coplanar with the shaft 16. The vertical grip handle 12.2 is particularly for use with a machete and saw tool head 22.3, axe tool head 22.4 and mallet tool head 22.7. It is to be appreciated that the use of the vertical grip handle 12.2 is not limited to use with the mentioned tool heads.

In this example of the invention the extendible shaft 16 includes three shaft sections 16.1, 16.2, 16.3 inter-connectable with each other to assemble a suitable shaft length for a particular tool assembly. The shaft sections 16.1, 16.2, 16.3 include inter-shaft connection formations 26 for connecting one shaft section to another. Each shaft section 16.1, 16.2, 16.3 includes a male inter-shaft connection formation 26.1 on one end and a female inter-shaft connection formation 26.2 on an opposed end.

In this example the inter-shaft connection formations 26, the handle-shaft connection formations 14 on the tool handles 12, and the tool head-shaft connection formations 24 on the tool heads 22 are in the form of threaded connection formations.

In this example the extendible shafts 16.1, 16.2, 16.3 are in the form of elongate tubular members. The tubular members are in the form of hollow metal tubing. In this example the hollow tubing has outer diameters of 32 mm. The wall thickness of the hollow tubing is 3 mm.

In this example there are two types of threaded connection formations that are releasably connectable to each other. The two types are in the form of spigot formations 14, 26.1, 20 and complementary socket formations 18, 26.2, 24. The spigot formations 14, 26.1, 20 have a male thread, and the socket formations 18, 26.2, 24 have a complementary female thread. In this example the handle-shaft connections formations 14 on the tool handles 12, the male inter-shaft connection formations 26.1 on the shaft sections 16 and the tool head connection formation 20 on the shaft 16 are in the form of identical threaded spigot formations. In this example the handle connection formations 18 on the shaft 16, the female inter-shaft connection formations 16.2 on the shaft sections 16 and the tool head-shaft connection formations 24 on the tool heads 22 are in the form of identical threaded socket formations.

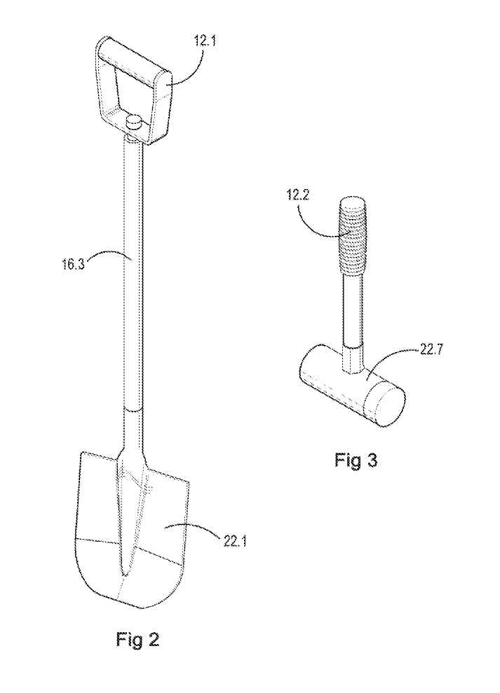

FIG. 2 shows a shovel assembled from the working toolkit 10. The shovel is assembled by screwing the handle-shaft connection formation 14 on the transverse grip handle 12.1, into the handle connection formation on one shaft section 16.3. The tool head connection formation 20 of the shaft section 16.3 is then screwed into the tool head-shaft connection formation 24 of the round shovelhead 22.1.

FIG. 3 shows a mallet assembled from the working toolkit 10. The mallet is assembled by screwing the handle-shaft connection formation 14 on the vertical grip handle 12.2, into the tool head-shaft connection formation 24 on the mallet head 22.7. In this example, no shaft section is necessary and the tool head-shaft connection formation 24 on the mallet head 22.7 serves as a handle connection formation.

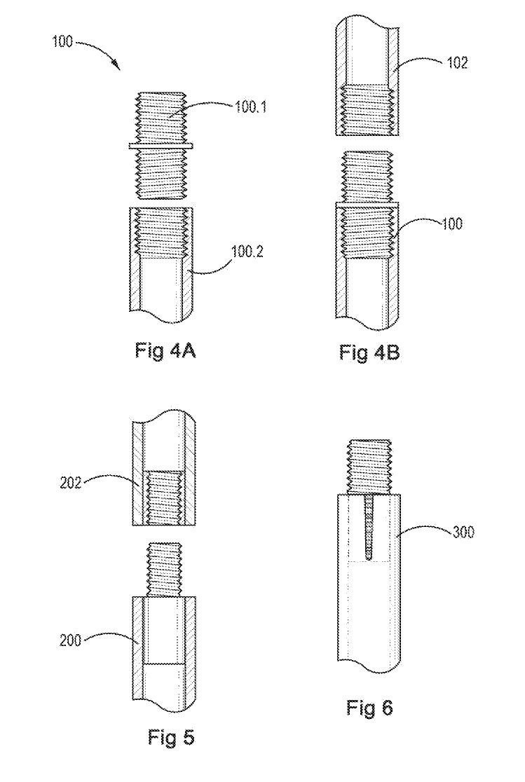

FIGS. 4A and 4B show one example of the spigot 100 and corresponding socket formation 102. In this example the male threaded insert 100.1 includes two male threaded studs on each end, and a smooth shoulder portion in between the studs. One male threaded stud is screwed into a female threaded formation 100.2 on the shaft 16. The insert is then welded onto the shaft 16, to produce the spigot formation 100.

In this example the threaded socket connection formation 102 and female threaded formation 100.2 is machined into the inner wall of the tubular shaft 16.

FIG. 5 shows another example of the spigot 200 and corresponding socket formation 202. In this example the threaded connection formations are in the form of threaded inserts, inserted into one end of the shaft 16. As shown in FIG. 5 the socket formation 202 is constructed by inserting a female threaded insert into the end of the shaft 16. The female threaded insert is cylindrical and has a smooth round outer wall and a threaded inner wall. The smooth round outer wall is dimensioned to fit tightly into the tubular shaft 16.

The spigot formation 200 is constructed by inserting a male threaded insert into the end of the shaft 16, such that a male thread portion of the insert extends beyond the end of the shaft 16. The male threaded insert includes a smooth cylindrical portion on one end and a threaded stud on an opposed end. The smooth cylindrical end is dimensioned to fit tightly into the tubular shaft 16.

The threaded may include fastening means, for fastening the inserts in the end of the shaft 16. In FIGS. 4 and 5 the fastening means are in the form of the inserts being friction fitted into the shaft 16 and thereafter welded onto the shaft 16.

FIG. 6 shows another embodiment of the spigot formation 300. In FIG. 6 the fastening means is in the form of constriction means. The constriction means includes a slit cut into a wall of an end of the shaft 16, which is welded closed when the insert is received into that end of the shaft 16, such that the wall of the shaft 16 is constricted around the insert.

In these examples the tool heads 22 have socket formations and the tool handles 12 have spigot formations. In other examples (not shown), the tool heads 22 may have spigot formations and the tool handles 12 may have socket formations.

In use different tools can be assembled from the different tool handles 12, shaft 16 and tool heads 22. In this example the tools that can be assembled include any one of, a round head shovel, a straight head spade, a machete/saw, an axe, a rake, a broom and a mallet.

The working toolkit 10 may include a carry bag (not shown) having separate pockets shaped and dimensioned to receive the tool handles 12, shaft sections 16 and tool heads 22.

The order of execution or performance of the methods and techniques illustrated and described herein is not essential, unless otherwise specified. That is, elements of the methods and techniques may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A working toolkit, which includes:
an extendible shaft having a handle connection formation on one end of the shaft and a tool head connection formation on an opposed end of the shaft;
at least one tool handle having a handle-shaft connection formation for releasably attaching the tool handle to the handle connection formation; and
at least one tool head having a tool head-shaft connection formation for releasably attaching the tool head to the tool head connection formation, thereby to provide an assembled tool.

2. The working toolkit as claimed in claim 1, in which the at least one tool handle is in the form of any of a vertical grip handle and a transverse grip handle, wherein the vertical grip handle when connected to the shaft extends substantially parallel to an elongate direction of the shaft, and wherein the transverse grip handle extends substantially non-parallel to the elongate direction of the shaft.

3. The working toolkit as claimed in claim 1, in which the extendible shaft is in the form of a telescopically extendible shaft.

4. The working toolkit as claimed in claim 1, in which the extendible shaft includes a plurality of shaft sections releasably inter-connectable with each other to assemble a suitable shaft length for a particular tool assembly, and wherein the shaft sections include inter-shaft connection formations for connecting one of the shaft sections to another one of the shaft sections.

5. The working toolkit as claimed in claim 4, in which the inter-shaft connection formations, the handle-shaft connection formation, and the tool head-shaft connection formation are in the form of threaded connection formations.

6. The working toolkit as claimed in claim 4, in which the inter-shaft connection formations, the handle-shaft connection formation, and the tool head-shaft connection formation are in the form of complementary outwardly biased push-pins and one or more apertures for receiving the push pins.

7. The working toolkit as claimed in claim 5, in which the threaded connection formations comprise a spigot formation having a male thread and a complementary socket formation having a complementary female thread.

8. The working toolkit as claimed in claim 7, in which the shaft is tubular, and in which the threaded connection formations comprise threaded inserts, inserted into one end of the shaft.

9. The working toolkit as claimed in claim 8, in which the socket formation is constructed by inserting a female threaded insert into one end of the shaft.

10. The working toolkit as claimed in claim 9, in which the female threaded insert is cylindrical and has a smooth round outer wall and a threaded inner wall, the smooth round outer wall being dimensioned to fit tightly into the tubular shaft.

11. The working toolkit as claimed in claim 8, in which the spigot formation is constructed by inserting a male threaded insert into one end of the shaft, such that a male thread portion of the insert extends beyond the end of the shaft.

12. The working toolkit as claimed in claim 11, in which the male threaded insert includes a smooth cylindrical portion on one end and a threaded stud on an opposed end, the smooth cylindrical end being dimensioned to fit tightly into the tubular shaft.

13. The working toolkit as claimed in claim 11, in which the male threaded insert includes two male threaded studs on opposite ends of the male threaded insert, and a smooth shoulder portion in between the studs, wherein one of the male threaded studs is screwed into a female threaded formation on the shaft.

14. The working toolkit as claimed in claim 11, in which the male threaded inserts is any one of crimped or welded onto the shaft, to produce the spigot formation.

15. The working toolkit as claimed in claim 7, in which the threaded socket formation is machined into an inner wall of the tubular shaft.

16. The working toolkit as claimed in claim 8, in which the threaded inserts include fastening means, for fastening the inserts in the end of the shaft, in which the fastening means is selected from any one of: the insert being friction fitted into the shaft; the shaft including grub screws for fastening the insert to the shaft; and constriction means.

17. The working toolkit as claimed in claim 7, in which each shaft section includes a spigot formation on one end and a socket formation on an opposed end, and in which the tool head and the tool handle include either of a spigot formation or a socket formation.

18. The working toolkit as claimed in claim 7, in which either the tool head has a socket formation and the tool handle has a spigot formation that is complementary to the socket formation of the tool head, or the tool head has a spigot formation and the tool handle has a socket formation complementary to the spigot formation of the tool head.

19. The working toolkit as claimed in claim 1, in which the working toolkit includes a plurality of selectable tool handles and a plurality of selectable tool heads, such that different tools may be assembled from the different tool handles, shaft and tool heads.

20. The working toolkit as claimed in claim 19, in which the tools that can be assembled include any one or more of, a round head shovel, a straight head spade, a machete, a saw, an axe, a rake, a broom, a hammer and a mallet.
